(19) United States
(12) Patent Application Publication
(10) Pub. No.: US 2024/0012515 A1
(43) Pub. Date: Jan. 11, 2024

(54) Electrostatic Discharge Mitigation Systems and Methods

(71) Applicant: Apple Inc., Cupertino, CA (US)

(72) Inventors: Pablo Moreno Galbis, Burlingame, CA (US); Xiang Lu, Campbell, CA (US); Bin Huang, San Jose, CA (US); Ling Zhang, Saratoga, CA (US); Nikhil Acharya, Mountain View, CA (US); Derek K. Shaeffer, Redwood City, CA (US); Stanley B. Wang, Cupertino, CA (US); Yongjie Jiang, Santa Clara, CA (US); Hopil Bae, Palo Alto, CA (US); Jiayi Jin, Redwood City, CA (US); Ce Zhang, Cupertino, CA (US); Young Don Bae, San Jose, CA (US); Giovanni Azzellino, San Jose, CA (US); Wooseung Yang, San Jose, CA (US); Mahdi Farrokh Baroughi, Santa Clara, CA (US); Weijun Yao, Saratoga, CA (US); Rajesh Velayuthan, Pleasanton, CA (US); Eric A. Hildebrandt, San Jose, CA (US); Henry C. Jen, Los Altos, CA (US)

(21) Appl. No.: 18/212,099

(22) Filed: Jun. 20, 2023

Related U.S. Application Data
(60) Provisional application No. 63/358,755, filed on Jul. 6, 2022.

(51) Int. Cl. G06F 3/041

(52) U.S. Cl. CPC G06F 3/0418; G06F 2203/04107; G06F 3/044

(57) ABSTRACT

Touch sensitive display technologies (e.g., integrated touch-display pixel-based systems) are evolving to contain more analog and digital circuits inside the panel itself instead of the traditionally simple thin-film transistors. This improves the display characteristics but makes those circuits more vulnerable to the impact of external ESD strikes, which can degrade the user experience. This disclosure describes a series of circuits and techniques to mitigate the impact of these discharges on front of screen artifacts and potential false touches. These circuits and techniques may include: performing configuration-only panel updates independently of the image refresh rate, improving the in-panel memory circuits to make them resistant to unexpected pin toggles via disabling of a write path in response to a read clock, implementing a pin corruption detector and implementing a supply injection detector.

### CROSS-REFERENCE TO RELATED APPLICATIONS

This application claims priority to U.S. Provisional Application No. 63/358,755, filed Jul. 6, 2022, entitled “ELECTROSTATIC DISCHARGE MITIGATION SYSTEMS AND METHODS,” the disclosure of which is incorporated by reference herein in its entirety for all purposes.

### SUMMARY

The present disclosure relates generally to electronic devices with display panels and, more particularly, to electrostatic discharge detection circuitry that compensates for electrostatic discharge experienced by a display panel.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Electronic displays may display images that present visual representations of information. Accordingly, numerous electronic systems—such as computers, mobile phones, portable media devices, tablets, televisions, virtual-reality headsets, and vehicle dashboards, among many others—often include or use electronic displays. In any case, an electronic display may generally display an image by actively controlling light emission from its display pixels. By adjusting the brightness of different color components of the display pixels, a variety of different colors may be generated that collectively produce a corresponding image. As used in this disclosure, the term “display pixel” refers to a sub-pixel (e.g., a red, green, or blue sub-pixel of an RGB pixel; a cyan, magenta, or yellow sub-pixel of a CMY pixel) of an electronic display.

Display pixels may be formed from thin-film transistors. However, display technologies are evolving to include more analog and digital circuits inside the panel itself as opposed to using the thin-film transistors. While the inclusion of the analog and digital circuits may improve display characteristics (e.g., improve a perceived quality of a presented image frame), the inclusion of the analog and digital circuits make the electronic display more vulnerable to electrostatic discharge spikes. Electrostatic discharge may result when a display is at a relatively high level of static voltage and a tactile input is received, causing an injected current to transit via the display panel of the electronic display. Static voltages may be as high as 35,000 Volts (V) or even higher when an electronic device is in relatively low relative humidity (e.g., 10-25% relative humidity) or when temperatures are relatively low, such as when temperatures are less than 0° F. Other conditions may exist where electrostatic discharge causes undesirable electronic device operation. Indeed, image artifacts and visual errors resulting from the electrostatic discharge affecting digital circuitry may disrupt the desired effect or experience for users when viewing image content on the electronic display. Yet replacing an entire display due to disruption from the electrostatic discharge may be costly, time consuming, and inefficient. Accordingly, mitigating effects of the electrostatic discharge may be desirable to manufacturers as well as to users viewing the image content on the electronic display.

The electronic display may take a variety of forms and may include or be associated with more than one electronic display. For example, the electronic display may be a digital display such as a micro-light-emitting diode (LED) display and/or may present image content coordinated or associated with image content spanning more than one display active areas. A micro-LED display includes active matrixes of micro-LEDs, pixel drivers (e.g., referred to as micro-drivers), anodes, and arrays of row and column drivers. Each micro-driver may drive a number of display pixels on the electronic display. For example, each micro-driver may be connected to numerous anodes, and each anode may selectively connect to multiple different display pixels (one at a time). Thus, a collection of display pixels may share a common anode connected to a micro-driver. The micro-driver may drive a display pixel by providing a driving signal across an anode to one of the collection of display pixels. Any suitable number of display pixels may be located on respective anodes of the micro-LED display. Moreover, the collection of display pixels located on each anode may be the same particular color (e.g., red, green, blue). In some embodiments, the electronic display may be part of an electronic device. In other embodiments, the electronic display may be part of an external electronic display communicatively coupled to the electronic device. Processing circuitry (e.g., image processing circuitry, image compensation circuitry) of the electronic device or the electronic display may receive image data associated with displaying image content on the electronic display. In other embodiments, the processing circuitry may generate the image data.

Accordingly, the present disclosure provides systems and methods to compensate for effects of electrostatic discharge (ESD) on an electronic display (e.g., micro-LED display). When left unmitigated, the effects of the electrostatic discharge may create visual artifacts that are visible via the image content of the electronic display (e.g., front of screen artifacts). In some systems, the electrostatic discharge may impact touch detection operations, leading to inaccurate touch detection. Inaccurate touch detection may reduce a responsiveness of the electronic device to a touch input, negatively impact user experience, launch undesired or unintended software of the electronic device, which may slow processing operations by increasing computing resources consumed by undesired operations, and the like. Furthermore, a variety of entry and electrical coupling paths connect between processing circuitry and the display receiving the electrostatic discharge. If left unmitigated, electrostatic discharge may undesirably affect processing circuitry and/or a flex cable coupling between the display and the rest of the electronic device.

With this in mind, systems and methods described herein may include a series of circuits and operations to mitigate the impact of electrostatic discharges. The systems and methods described here may mitigate electrostatic discharge based on configuration panel updates made independent of a refresh rate of image content, based on improving circuit resiliency to the electrostatic discharge, implementing a pin corruption detector, and/or by implementing a supply injection or bounce detector. As will be appreciated, one or more of these systems and methods may be combined together or used separately as a standalone mitigation for electrostatic discharge. Mitigating the impact of electrostatic discharge may improve user experience and processing operations of the electronic device while reducing a likelihood that undesired effects to the processing circuitry, flex cable, or other circuitry of the electronic display from the electrostatic discharge occur.

To elaborate, one example of mitigation systems and methods may include performing configuration panel updates independent of a refresh rate of image content presented via the electronic display. Processing circuitry may detect that configuration data of a display panel is corrupted in response to an electrostatic discharge. In response to detecting the corruption, the processing circuitry may reload the configuration data of the display panel to mitigate the effects of the electrostatic discharge.

Another example of mitigation systems and methods may include improving in-panel memory circuits to make the circuitry more resilient to unexpected pin toggles associated with the electrostatic discharge. Circuitry may be included in the micro-driver that protects the memory of the micro-driver from having stored data being corrupted via electrostatic discharge. The circuitry may disable the memory from being read or written to unless the processing circuitry is accessing the memory.

Yet another example of mitigation systems and methods may include including circuitry that implements a pin corruption detector and/or a supply injection detector in the electronic display. The pin corruption detector and/or the supply injection detector may determine when an injected charge is received from the electrostatic discharge, such as when the electrostatic discharge affects signals transmitted to the micro-driver. In response to determining the injected charge, the pin corruption detector and/or the supply injection detector may generate an indication that is transmitted to processing circuitry. The processing circuitry may reconfigure the display panel in response to receiving the indication to reset the configuration data which may be corrupted from the electrostatic discharge.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device with an electronic display, in accordance with an embodiment of the present disclosure;

FIG. 2 is a front view of a handheld device representing another embodiment of the electronic device of FIG. 1;

FIG. 3 is a front view of another handheld device representing another embodiment of the electronic device of FIG. 1;

FIG. 4 is a perspective view of a notebook computer representing an embodiment of the electronic device of FIG. 1;

FIG. 5 is a front view and side view of a wearable electronic device representing another embodiment of the electronic device of FIG. 1;

FIG. 6 is a front view of a desktop computer representing another embodiment of the electronic device of FIG. 1;

FIG. 7 is a block diagram of a micro-LED display that employs micro-drivers to drive display pixels with controls signals, in accordance with an embodiment;

FIG. 8 is a block diagram schematically illustrating an operation of a micro-driver of FIG. 7, in accordance with an embodiment of the present disclosure;

FIG. 9 is a timing diagram illustrating an example operation of the micro-driver of FIG. 8, in accordance with an embodiment of the present disclosure;

FIG. 10 is a schematic illustration of the micro-LED display of FIG. 7, where a micro-driver controls a collection of display pixels based on a digital code, in accordance with an embodiment of the present disclosure;

FIG. 11 is a diagrammatic representation of a touch sensor array and a display pixel array integrated in an electronic display of the electronic device of FIG. 1, in accordance with an embodiment

FIG. 12 is a diagrammatic representation of image artifacts and/or effects of electrostatic discharge, in accordance with an embodiment of the present disclosure;

FIG. 13 is a flow diagram of a method of mitigating electrostatic discharge that may otherwise lead to the first category of image artifacts, in accordance with an embodiment of the present disclosure;

FIG. 14 is a circuit diagram of an example memory of a micro-driver that may include disabling circuitry to selectively disable a write path to a memory cell of the memory, in accordance with an embodiment of the present disclosure;

FIG. 15 is a circuit diagram of a pin corruption detector and supply injection detector, in accordance with an embodiment of the present disclosure; and

FIG. 16 is a timing diagram corresponding to an example operation of the pin corruption detector and the supply injection detector of FIG. 15, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

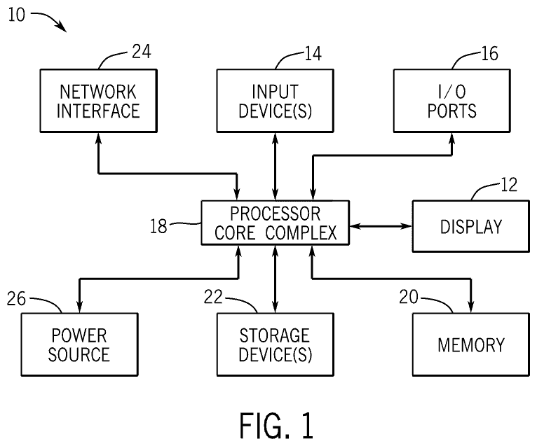

With the preceding in mind and to help illustrate, an electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, and a power source 26 (e.g., power supply). The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

In addition to enabling user inputs, the electronic display 12 may include a display panel with one or more display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW arrangement).

The electronic display 12 may display an image by controlling light emission from its display pixels based on pixel or image data associated with corresponding image pixels (e.g., points) in the image. In some embodiments, pixel or image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on pixel or image data generated by the processor core complex 18, or the electronic display 12 may display frames based on pixel or image data received via the network interface 24, an input device, or an I/O port 16.

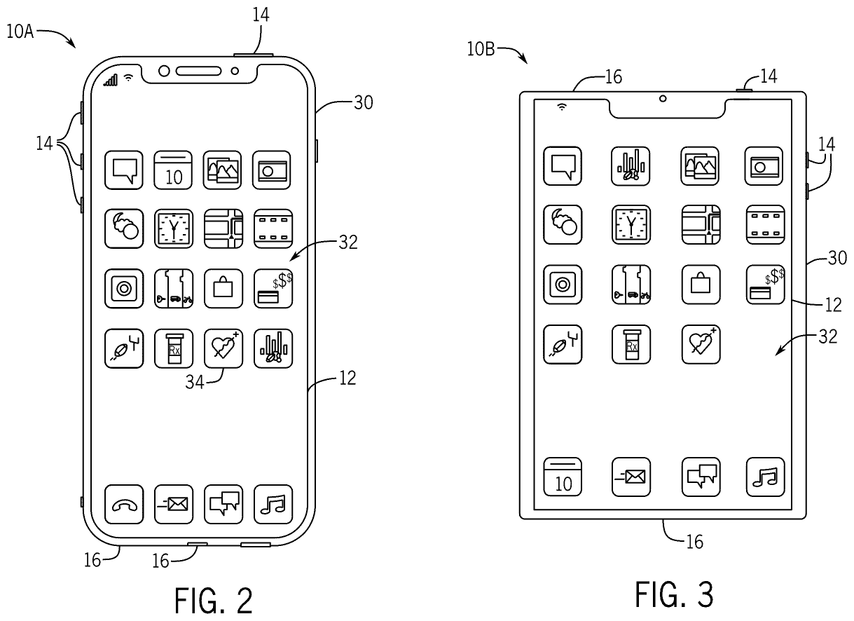

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smartphone, such as an IPHONE® model available from Apple Inc.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

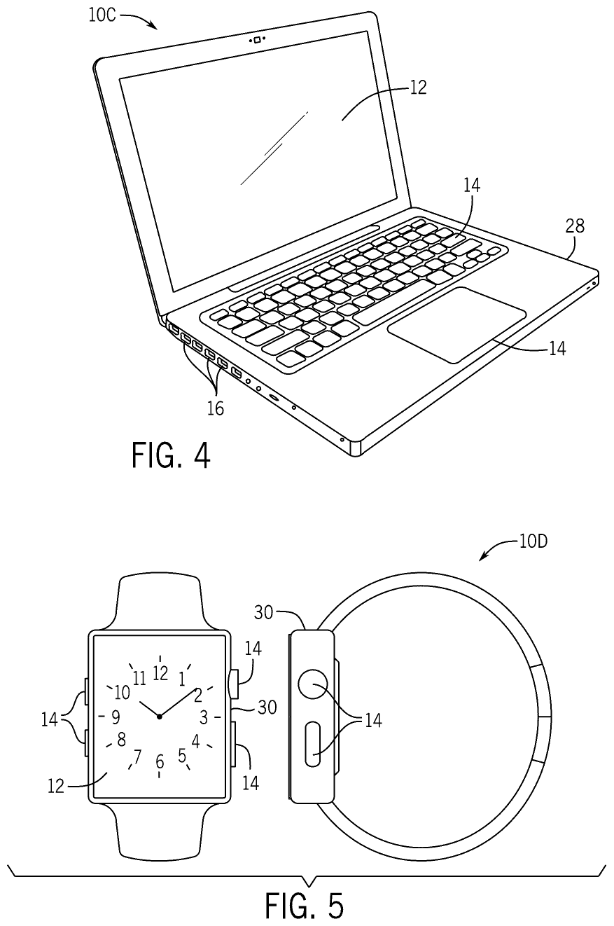

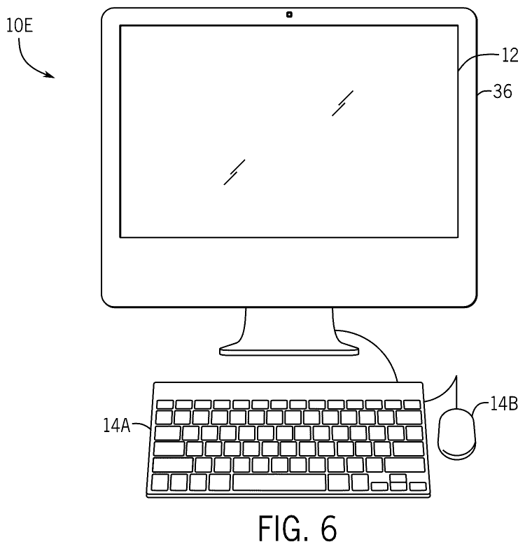

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

Turning to FIG. 6, a computer 10E may represent another embodiment of the electronic device 10 of FIG. 1. The computer 10E may be any suitable computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure or housing 36 may be provided to protect and enclose internal components of the computer 10E, such as the electronic display 12. In certain embodiments, a user of the computer 10E may interact with the computer 10E using various peripheral input structures 14, such as the keyboard 14A or mouse 14B (e.g., input structures 14), which may connect to the computer 10E.

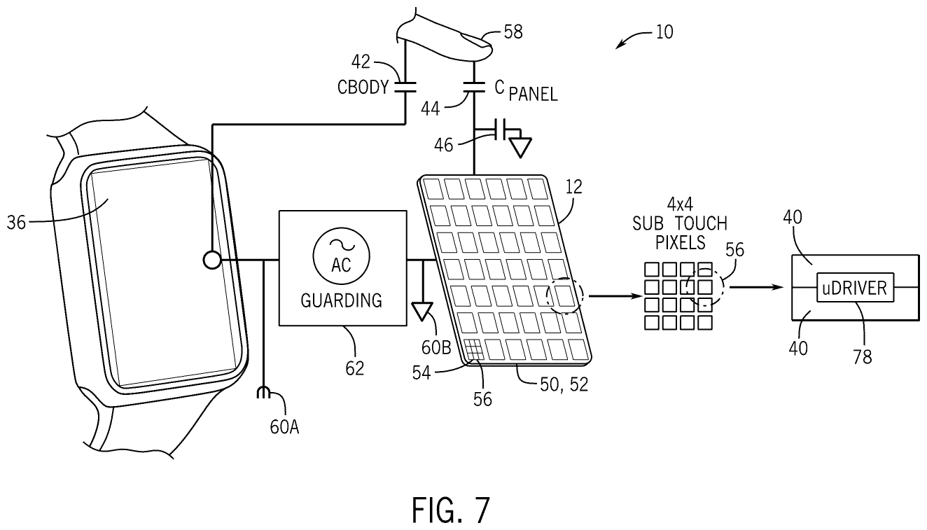

FIG. 7 is a diagrammatic representation of a portion of the electronic device 10 with the housing 36. Illustrated is an example circuitry used to sense a tactile input 58 to the electronic display 12, such as while an image frame is presented. Capacitances 42, 44, and 46 may represent a material capacitance or an added capacitance component to the electronic device 10, where a capacitance 42 represents a capacitance of the housing 36 of the electronic device 10 and/or circuitry associated with the body of the electronic device 10 (Cbody), a capacitance 44 represents a capacitance between a user or a tool (e.g., stylus) causing the tactile input 58, and a capacitance 46 represents another capacitance between the electronic display 12 and the ground 60B system. Resistances and inductances may be omitted from the diagram.

As will be appreciated, the display pixel array 50 includes many display pixels and the touch sensor array 52 includes many touch pixels corresponding to touch sub-pixels 56 or touch sensing regions formed at intersections of touch sensing-related electrodes (e.g., intersection of row electrodes and column electrodes). Respective touch sub-pixels 56 may correspond to respective arrays 40 of display pixels, and thus the display pixel array 50 may include a greater number of the display pixels than the touch sub-pixels 56. For example, a 4×4 grid of touch sub-pixels 56 be disposed in a location adjacent or proximate to (e.g., above or below in a different substrate layer) two arrays 40 of display pixels and one micro-driver 78.

The display pixels may each include one or more self-emissive elements, such as a light-emitting diodes (LEDs) (e.g., organic light emitting diodes (OLEDs) or micro-LEDs (μLEDs)), however other pixels may be used with the systems and methods described herein including but not limited to liquid-crystal devices (LCDs), digital mirror devices (DMD), or the like, and include use of displays that use different driving methods than those described herein, including partial image frame presentation modes, variable refresh rate modes, or the like.

The electronic device 10 may use a first ground 60A. A display pixel array 50 and a touch sensor array 52 may use a different ground system than the rest of the electronic device 10, a second ground 60B, to sense the tactile input 58. Ground isolation circuitry 62 may isolate the first ground 60A and the second ground 60B, such as by alternating coupling (AC) systems and methods. When the electronic device 10 is powered through battery power, the first ground 60A may be a ground of the battery (e.g., a battery referred ground).

Electrostatic discharges associated with the tactile input 58 may have a suitable voltage value to damage circuitry associated with the electronic display 12 if left unmitigated. As will be appreciated, mitigation systems and methods are described herein to reduce an impact from electrostatic discharge to the integrated display pixel array 50 and touch sensor array 52.

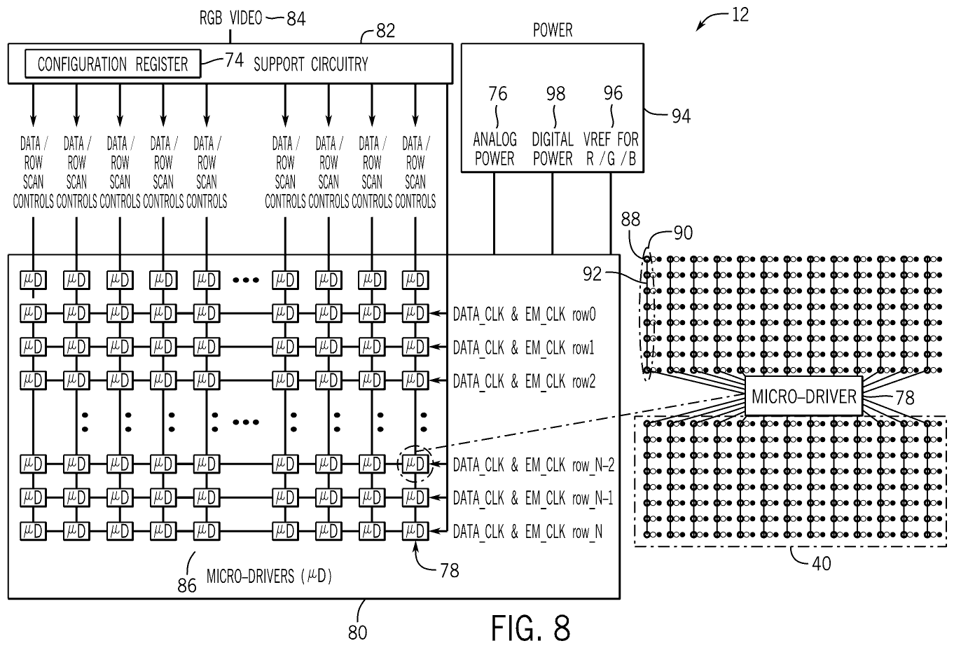

FIG. 8 depicts a block diagram of an example architecture of the electronic display 12 (e.g., micro-LED display 12) that includes micro-drivers 78 (μDs, μDrivers). In the example of FIG. 8, the micro-LED display 12 uses an RGB display panel 80 with pixels that include red, green, and blue micro-LEDs as display pixels. Support circuitry 82 may receive RGB-format video image data 84 and may include a configuration register 74. It should be appreciated, however, that the micro-LED display 12 may display other formats of image data, in which case the support circuitry 82 may receive image data of such different image format. In some embodiments, the support circuitry 82 may include a video timing controller (video TCON) and/or emission timing controller (emission TCON) that receives and uses the image data 84 in a serial bus to determine a data clock signal (DATA_CLK) and/or a emission clock signal (EM_CLK) to control the provision of the image data 84 in the micro-LED display 12. The video TCON may also pass the image data 84 to a serial-to-parallel circuitry that may deserialize the image data 84 signal into several parallel image data signals. That is, the serial-to-parallel circuitry may collect the image data 84 into the particular data signals that are passed on to specific columns among a total of M respective columns in the display panel 80. As noted above, the video TCON may generate the data clock signal (DATA_CLK), and the emission TCON may generate the emission clock signal (EM_CLK). Collectively, these may be referred to as Data/Row Scan Control signals, as illustrated in FIG. 8. As such, the data is labeled DATA/ROW SCAN CONTROLS. The data/row scan controls respectively contain image data corresponding to pixels in the first column, second column, third column, fourth column . . . fourth-to-last column, third-to-last column, second-to-last column, and last column, respectively. The data/row scan controls may be collected into more or fewer columns depending on the number of columns that make up the display panel 80.

In particular, the display panel 80 columns include micro-drivers 78 corresponding to the arrays 40 of display pixels 88. The micro-drivers 78 are arranged in an array 86. The micro-drivers 78 may receive and/or pass on various signals sent from the support circuitry 82. By way of example, micro-drivers 78 on the left-hand side of the display may receive row scan control signals and pass those signals that correspond to its particular row to other micro-drivers 78 in that row of micro-drivers 78. Each micro-driver 78 drives a number of display pixels 88. Different display pixels (e.g., display sub-pixel) 88 may include different colored micro-LEDs (e.g., a red micro-LED, a green micro-LED, or a blue micro-LED) to represent the image data 84 in RGB format. Although one of the micro-drivers 78 of FIG. 7 is shown to drive twenty-six anodes 90 having eight display pixels 88 each, each micro-driver 78 may drive more or fewer anodes 90 (e.g., 8 anodes, 9 anodes, 10 anodes, 11 anodes, 12 anodes, 14 anodes, 15 anodes, 16 anodes, 17 anodes, 18 anodes, and so forth) and respective display pixels 88. As illustrated, the subset of display pixels 88 located on each anode 90 may be associated with a particular color (e.g., red, green, or blue). As mentioned above, it should be noted that a respective anode corresponds to a subset of display pixels 88 associated with a particular color even though each anode for a particular color channel is not illustrated in FIG. 8. For example, anode 92 corresponds to a red color channel (e.g., subset of red display pixels 88). There may be a second set of anodes that couple to a green color channel (e.g., subset of green display pixels 88) and a third set of anodes that couple to a blue color channel (subset of blue display pixels 88), but these are not expressly illustrated in FIG. 7 for ease of illustration.

A power supply 94 may provide a reference voltage (VREF) 96 to drive the micro-LEDs, a digital power signal 98, and an analog power signal 76. In some cases, the power supply 94 may provide more than one reference voltage (VREF) 96 signal. Namely, display pixels 88 of different colors may be driven using different reference voltages. As such, the power supply 94 may provide more than one reference voltage (VREF) 96. Additionally or alternatively, other circuitry on the display panel 80 may step the reference voltage (VREF) 96 up or down to obtain different reference voltages to drive different colors of micro-LED. It is noted that FIG. 8 shows one example of a display 12 that includes micro-drivers 78, and it should be understood that other arrangements of connections may be used to provide the micro-drivers 78 and the display 12

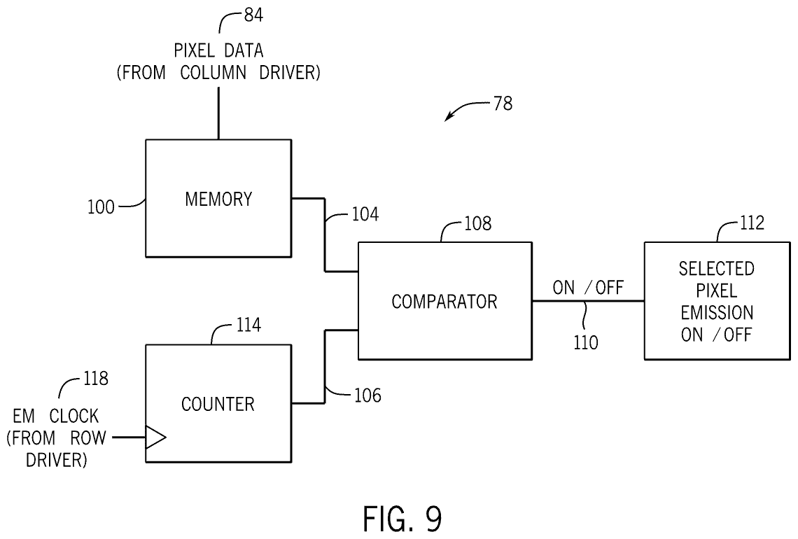

A block diagram shown in FIG. 9 illustrates some of the components of one of the micro-drivers 78. The micro-driver 78 of FIGS. 7-8 includes memory 100. The memory 100 may include sufficient storage to hold image data 84 that is provided (e.g., as a digital code). For instance, the micro-driver 78 may include memory 100 to store image data 84 for a display pixel 88 at any one time (e.g., 8-bit image data 84 may use 24 bits of storage). It should be appreciated, however, that the micro-driver 78 may include more or fewer memory 100, depending on the data rate of the image data 84 and the number of display pixels 88 included in the image data 84. The memory 100 may take any suitable logical structure based on the order that a column driver provides the image data 84. For example, the memory 100 may include buffers having a first-in-first-out (FIFO) logical structure or a last-in-first-out (LIFO) structure, memory cells including a static random access memory (SRAM) inverter pair, an inverter pair, or another suitable storage structure.

When the pixel data buffer(s) 100 has received and stored the image data 84, the micro-driver 78 may provide the emission clock signal (EM_CLK) 118. A counter 114 may receive the emission clock signal (EM_CLK) as an input. The pixel data memory 100 may output enough of the stored image data 84 to output a digital data signal 104 represent a desired gray level for a particular display pixel 88 that is to be driven by the micro-driver 78. The counter 114 may also output a digital counter signal 106 indicative of the number of edges (only rising, only falling, or both rising and falling edges) of the emission clock signal (EM_CLK) 118. The signals 104 and 106 may enter a comparator 108 that outputs an emission control signal 110 in an “on” state when the digital counter signal 106 does not exceed the signal 104, and an “off” state otherwise. The emission control signal 110 may be routed to driving circuitry (not shown) for the display pixel 88 being driven, which may cause light emission 112 from the selected display pixel 88 to be on or off. The longer the selected display pixel 88 is driven “on” by the emission control signal 110, the greater the amount of light that will be perceived by the human eye as originating from the display pixel 88.

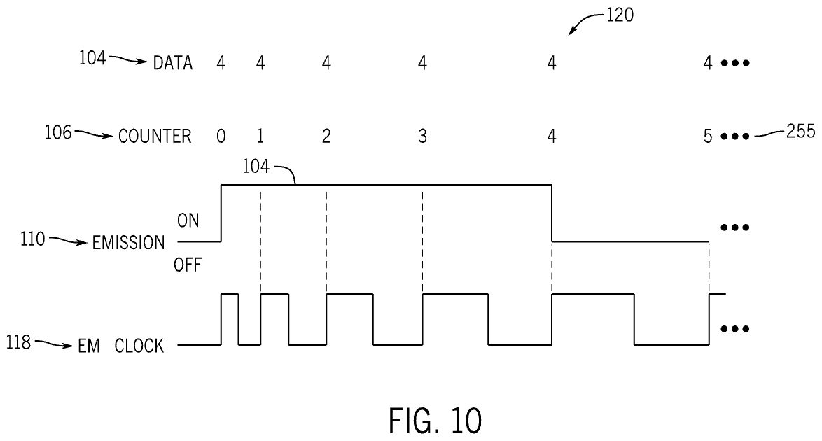

A timing diagram 120, shown in FIG. 10, provides one brief example of the operation of the micro-driver 78. The timing diagram 120 shows the digital data signal 104, the digital counter signal 106, the emission control signal 110, and the emission clock signal (EM_CLK) 118. In the example of FIG. 10, the gray level for driving the selected display pixel 88 is gray level 4, and this is reflected in the digital data signal 104. The emission control signal 110 drives the display pixel 88 “on” for a period of time defined as gray level 4 based on the emission clock signal (EM_CLK). Namely, as the emission clock signal (EM_CLK) rises and falls, the digital counter signal 106 gradually increases. The comparator 108 outputs the emission control signal 110 to an “on” state as long as the digital counter signal 106 remains less than the data signal 104. When the digital counter signal 106 reaches a value represented via the data signal 104, the comparator 108 outputs the emission control signal 110 to an “off” state, thereby causing the selected display pixel 88 no longer to emit light.

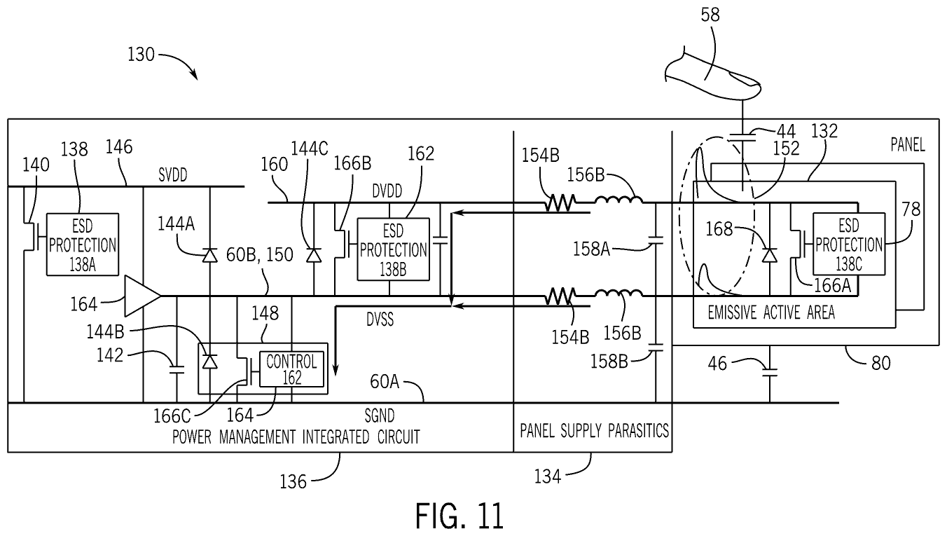

With the preceding in mind, FIG. 11 is a diagrammatic representation of a portion 130 of the electronic device 10 including an active area 132, panel supply parasitics 134, and a power management integrated circuit (PMIC) 136. The active area 132 may include micro-drivers 78 and emissive components, like the display pixel 88. The PMIC 136 may correspond to the power supply 94 of FIG. 8. In any case, the PMIC 136 may generate one or more signals, such as based on signals supplied from a power source, like a battery power source, for dissemination to the active area 132 and the panel supply parasitics 134. The PMIC 136 may include ESD protection circuits 138, an ESD protection switch 140 (e.g., that selectively couples a supply rail on path 146 to ground 60A in response to ESD being detected by ESD protection circuit 138A), a capacitor 142 (e.g., parasitic capacitance of 500 picofarads (pF), 800 pF, any suitable value), diodes 144 (diode 144A, diode 144B, diode 144C), or the like. One or more of the ESD protection circuits 138 (ESD protection circuit 138A, ESD protection circuit 138B, ESD protection circuit 138C) may include one or more resistors, one or more capacitors, or other suitable circuitry to protect the electronic device 10 from ESD. Characteristics (e.g., resistance, capacitance) of the ESD protection circuits 138 may respectively cause a corresponding switch to open or close. A diode 168 and additional RC triggered ESD protection (e.g., switch 166A and ESD protection 138C) may also be included in the active area 132. The ESD protection 138B may couple to an ESD protection switch 166B, which may be turned on or off based on ESD (e.g., to redirect to ground). The display panel 80 may include one or more active areas 132 each having one or more micro-drivers 78 and one or more arrays 40 of display pixels 88.

To elaborate, the PMIC 136 may include processing circuitry that controls supply signals for the electronic device 10. The PMIC 136 may receive a system supply voltage (SVDD) via path 146. The system supply voltage may be any suitable voltage value, such as a voltage between 4-6 Volts (V), approximately 5V, a voltage between 5.1-5.5V, approximately and the like. Switching circuitry 148 may include control circuitry 162 that decides between shorting the grounds of the display 12 or isolating the grounds of the display 12. Indeed, switching circuitry 148 may short the grounds by coupling a system ground (SGND)) to a display low reference voltage (DVSS) on path 150 using switch 166C control circuitry 162. Notably, a system ground (SGND) may correspond to a first ground 60A system and the electronic display 12 may use a display low reference voltage (DVSS) may correspond to a second ground 60B system. The PMIC 136 may also perform touch stimulation operations. Touch stimulation operations may involve the PMIC 136 generating voltage signals or current signals used to detect a change in capacitance associated with the tactile input 58 and based on the capacitance 44, such as based on touch stimulation signals that come from an amplifier (e.g., amplifier 164).

With this in mind, sometimes a tactile input, such as the tactile input 58, causes electrostatic discharge (ESD) that transmits an injected charge 152 from a display panel 80 (e.g., display panel 80 associated with the display pixel array 50 and the touch sensor array 52) to other portions of the electronic device 10. When using a display with micro-drivers 78, the injected charge 152 may transmit through supply voltages of each micro-driver 78 to a top of the electronic display 12 and into a power management integrated circuit (PMIC) 136 to find a relatively low impedance path out from the PMIC 136. Indeed, when the electrostatic discharge occurs, a displacement current (e.g., injected charge 152) may be injected via cathodes of the micro-drivers 78 and may dissipate via the micro-driver 78 to the panel ground 60B while a glass surface of the display panel 80 (e.g., where the tactile input 58 is received) stays at a relatively high voltage for one or more seconds (s). Impedance may cause a common mode and/or differential jump in the digital supplies (DVDD and DVSS) of the micro-drivers 78. Furthermore, in route to the PMIC 136, the injected charge 152 may transmit via panel supply parasitics 134, represented by resistive devices 154 (resistive device 154A, resistive device 154B), inductive devices 156 (inductive device 156A, inductive device 156B), and capacitive devices 158 (capacitive device 158A, capacitive device 158B). Since the micro-drivers 78 may include both digital and analog circuitry, the micro-driver 78 may be sensitive to current and/or voltage differences associated with the injected charge 152. Thus, systems and methods described herein may mitigate effects of electrostatic discharge on operations of the micro-driver 78 and/or the display panel 80.

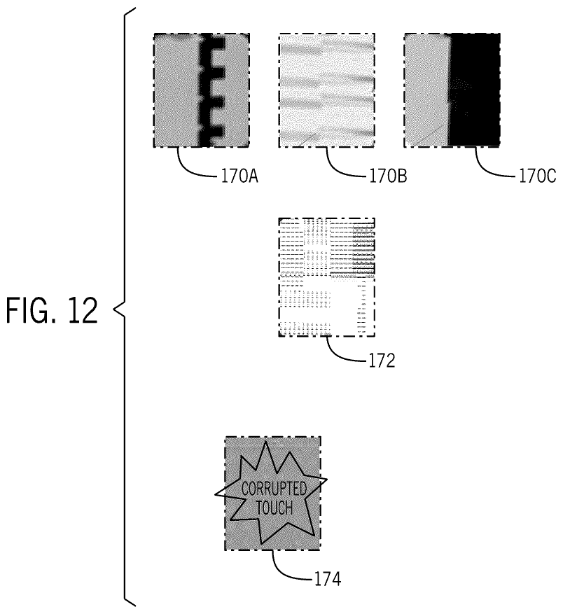

To help illustrate, FIG. 12 is a diagrammatic representation of image artifacts and/or effects of electrostatic discharge. Patterns 170 (pattern 170A, pattern 170B, pattern 170C), pattern 172, and diagram 174 are illustrated in FIG. 12. It is noted that some image artifacts are self-resolving, such as image artifacts resulting from emission clock corruption that may be caused by electrostatic discharge, which resolves at a next frame when an emission clock is regenerated. However, each of these are examples of image artifacts that may not be self-resolving without additional mitigation operations.

A first category of image artifacts may correspond to pattern 170A, pattern 170B, and/or pattern 170C. This first category of image artifact may result from undesired digital pin movements associated with injected charge 152 from electrostatic discharge transmitting through the display panel 80 that may cause the corruption of the micro-driver 78 configuration. In this example type of image artifact, the electrostatic discharge may disrupt configurations associated with the display panel 80 without also disrupting the image data stored in the memory 100 of the micro-drivers 78. Thus, a configuration of the display panel 80 may be reset to mitigate a corrupted configuration without also having to reload image data stored in the memory 100 of the micro-drivers 78. To mitigate corruption associated with the electrostatic discharge, the display panel 80 may be proactively or reactively reconfigured at a particular frequency, such as 60 Hertz (Hz). The proactive or reactive reconfiguration may use relatively low amounts of data and consume relatively low amounts of power since the image data stored in the micro-drivers 78 is not necessarily reloaded with each reconfiguration. Thus, even if an electrostatic discharge event causes corruption of a configuration of the display panel 80, an upcoming reconfiguration of the display panel 80 may reset the corrupted configuration with little to no perceivable impact to an image presented via the display panel 80.

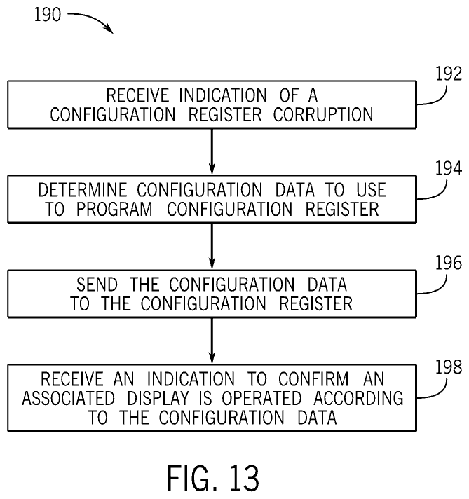

To elaborate, FIG. 13 is a flow diagram of a method 190 that provides a more in-depth discussion of mitigating electrostatic discharge that may otherwise lead to the first category of image artifacts. While the method 190 is described using process blocks in a specific sequence, it should be understood that the present disclosure contemplates that the described process blocks may be performed in different sequences than the sequence illustrated, and certain described process blocks may be skipped or not performed altogether. Furthermore, although the method 190 is described as being performed by processing circuitry, it should be understood that any suitable processing circuitry such as the processor core complex 18, image processing circuitry, image compensation circuitry, support circuitry 82 (e.g., timing controller of the support circuitry 82) may perform some or all of these operations.

At block 192, the processing circuitry may receive an indication of a configuration register 74 corruption, such as an indication of a corruption event occurring or an indication corresponding to occurrence of corruption. A detection circuit may generate the indication of a configuration register 74 corruption in response to detecting an electrostatic discharge. In some embodiments, the detection circuitry may generate the indication of a configuration register 74 corruption in response to detecting that the configuration register 74 or a configuration stored in the configuration register 74 is corrupted after an electrostatic discharge occurred. The processing circuitry may detect corruption to configuration data of the configuration register 74 comparing stored configuration data in the configuration register 74 to stored configuration data in storage 22 and determine if the data is different. In response to a threshold amount of difference between the expected stored configuration and the actual stored configuration, the detection circuit may generate the indication of the configuration register 74 corruption. It is noted that any suitable method of triggering a generation of generate an indication of a configuration register 74 corruption may be used.

At block 194, the processing circuitry may determine configuration data to use to program the configuration register 74, such as in response to the processing circuitry receiving the indication of the configuration register 74 corruption, and, at block 196, the processing circuitry may send the configuration data to the configuration register 74 to program the configuration register 74 with the configuration data. The processing circuitry may use same or different configuration data when programming the configuration register 74. The processing circuitry may modify existing or stored configuration data when determining the configuration data to use to program the configuration register 74. In the event that a configuration stored in the configuration register 74 became corrupted, the processing circuitry may load or may reload the same configuration to the register. This may include the processing circuitry determining that the configuration data stored in the configuration register 74 was corrupted from the electrostatic discharge based on the indication from block 192 and reading the configuration data from a memory external to the configuration register 74 in response to determining that the configuration data stored in the configuration register 74 was corrupted. In some systems, reloading of the configuration data occurs to provide a 60 Hz refresh rate independent of the indication at block 192 as a method to preemptively compensate for the corruption identified at block 192.

At block 198, the processing circuitry may receive an indication that confirms the electronic display 12 is being operated according to the configuration data in the configuration register 74. The configuration data used to program the configuration register 74 may indicate a display panel 80 refresh frequency of 60 Hz or another suitable refresh frequency. A suitable refresh frequency may correspond to a frequency value at which a corruption causing a visual artifact may occur and the visual artifact resulting be unperceivable to a viewer due to the relatively quick reset of the display panel 80. When refreshing the display panel 80 at 60 Hz, image data loaded into the memory 100 may be updated or changed at a different frequency. Thus, the display panel 80 may be refreshed independent from a reload of image data to the memory 100 of the micro-drivers 78. Refreshing the display panel 80 may reset configurations loaded into the configuration register 74, which may mitigate an effect of electrostatic discharge corrupting the configuration or the configuration register 74. By refreshing the configuration stored in the configuration register 74 (e.g., at a 60 Hz or other suitable frequency), visual artifacts or other effects of the display panel 80 resulting from the electrostatic discharge (e.g., patterns 170) may be unperceivable or not occur, thereby improving operation of the electronic device 10.

Referring back to FIG. 12, a second category of image artifacts may correspond to a pattern 172. This second category of image artifacts may result from the injected charge 152 causing an undesired data write into the memory 100 of the micro-driver 78, which may corrupt some or all of the stored image data in the memory 100. One way to mitigate the image artifacts resulting from a memory corruption (e.g., SRAM corruption) is to rewrite the image data, thereby correcting any corruption. However, this may consume relatively large amounts of power. Another solution may be to disable write and read access to the memory 100 of the micro-driver 78 unless a read or write operation is occurring or is to occur. By having write or read access normally disabled to the memory 100 of the micro-driver 78, the injected charge 152 from an electrostatic discharge may be unable to access the memory 100 of the micro-driver 78 and corrupt any stored image data.

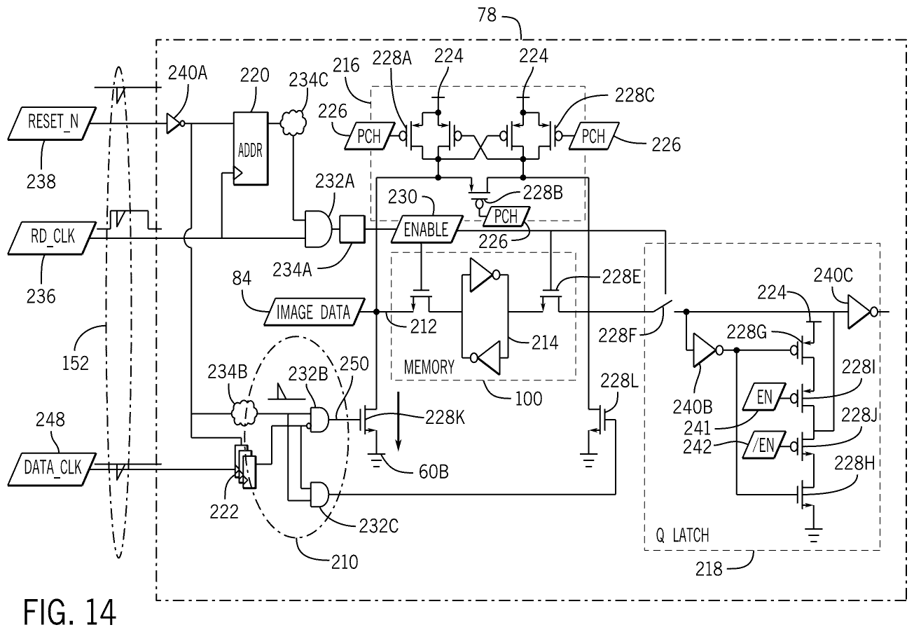

To elaborate, FIG. 14 is a circuit diagram of an example memory 100 of a micro-driver 78 that may include disabling circuitry 210 to selectively disable a write path 212 to a memory cell 214. By doing so, the disabling circuitry 210 may stop or reduce a likelihood of memory corruption occurring in response electrostatic discharge, and thus may mitigate the second category of image artifacts (e.g., pattern 172) caused by the memory corruption. One disabling circuitry 210 may be included for each memory cell 214, and thus a number of registers in the set of registers 222 may equal to a number of memory cells 214 and/or a number of disabling circuitry 210 included in the micro-driver 78. In some systems, a single disabling circuitry 210 is shared between multiple memory cells 214. In yet other systems, a single disabling circuitry 210 is coupled to a single memory cell 214.

The micro-driver 78 may include precharge circuitry 216, the memory cell 214, a first latch 218 (e.g., a Q latch), a first register 220, and a set of registers 222. The memory cell 214 may be preloaded with an initial precharge voltage, which may correspond to an initial data value. The precharge circuitry 216 may generate the precharge voltage based on a supply voltage 224 (e.g., display supply voltage (DVDD) sent via the path 160) when precharge control (PCH) signals 226 are received at switches 228 (switch 228A, switch 228B, switch 228C). The PCH signals 226 may be used to increase a voltage of at least some of the circuitry of the micro-driver 78, such as to increase a responsiveness of the circuitry.

An enable signal 230 may turn on switches 228 (switch 228D, switch 228E) to enable the memory cell 214 to be written with the image data 84. The micro-driver 78 may also include distribution circuitry 234 (distribution circuitry 234A, distribution circuitry 234B, distribution circuitry 234C) that may include any number of analog, digital circuits, such as switches, combinational logic, or the like to transmit an input into the distribution circuitry 234 to an output from the distribution circuitry 234. The micro-driver 78 may include multiple combinational logic circuits, including AND gates 232 (AND gate 232A, AND gate 232B, AND gate 232C). It is noted that one or more of the AND gates 232 and/or any other AND gate, OR gate, not-OR (NOR) gate, not-AND (NAND) gate, or the like described herein may be replaced with any suitable equivalent combinational logic circuit of OR gates, NOR gates, NAND gates, inverters, or the like.

The AND gate 232A may generate the enable signal 230. The AND gate 232A may generate one or more enable signals 230. Multiple enable signals 230 may be used when the memory 100 includes multiple memory cells 214.

The AND gate 232A may output the one or more enable signals 230 to the distribution circuitry 234A. The distribution circuitry 234A may transmit the one or more enable signals to multiple memory cells 214 (e.g., to respective switch 228D of the different memory cells 214), for example by distributing five enable signals 230 into thirty-two enable signals for thirty-two different memory cells 214, or any number of enable signals 230 into any number of enable signals 230 for the different memory cells 214.

To generate the enable signal 230, the AND gate 232A may receive an output from the register 220 via distribution circuitry 234C and a read clock (RD_CLK) signal 236. The RD_CLK signal 236 may be a clocking signal. The support circuitry 82 may generate the RD_CLK signal 236 to control a read operation used to read the data from the memory cell 214 to cause light emission according to the image data 84 stored in the memory cell 214. The register 220 may generate the output based on a reset (RESET_N) signal 238 input transmitted via the inverter 240A in response to a clocking transition of the RD_CLK signal 236. The RD_CLK signal 236 and the RESET_N signal 238 may both have an active logic high (e.g., active when logic high signal, “1”).

The support circuitry 82 may control data write operations that cause one or more memory cells 214 to be written to with image data 84 for storage. The support circuitry 82 may transmit the image data 84 to the memory cell 214 via the switch 228D. The memory cell 214 may include an inverter pair, a buffer, or the like to store the image data 84. The support circuitry 82 may transmit the image data 84 with the DATA_CLK 248 to control the writing of the image data 84 to the memory cell 214 and may stop the transmission of the DATA_CLK 248 when a write operation is not being performed. Here, a write operation may not be being performed, so the DATA_CLK 248 signal is held at a logic low level. The AND gate 232B may transmit a control signal on a path 250 to turn on switch 228K. The switch 228K may couple the memory cell 214 to ground 60B during a write operation. The AND gate 232B may include an inverted input to receive the output from the set of registers 222 and a non-inverted or normal input to receive an output from the distribution circuitry 234B. When the signal received via the inverted input of the AND gate 232B is a logic low signal and the input to the AND gate 232B from the distribution circuitry 234B is a logic high signal, the AND gate 232B may transmit a control signal on a path 250 to turn on switch 228K.

The support circuitry 82 may also control data read operations that may cause one or more memory cells 214 to be read and output stored data. Read image data 84 may output from the memory cell 214 to an inverter 240B and the inverter 240C. When the enable signal 230 is 0 or is a logic low signal, the switch 228E may open causing the data voltage stored in the memory cell 214 (e.g., the inverter pair) to not transmit from the memory cell 214. The enable signal 230 may close the switch 228E and a switch 228F to cause the memory cell 214 to read the image data 84 from the memory cell 214. The inverter 240B may transmit the data voltage to switch 228G and switch 228H. When switch 228I and switch 228J are both enabled by enable signal 241 and a complement of the enable signal 241 (/En signal 242), the supply voltage 224 value may transmit to the inverter 240C and output from the latch 218 to downstream light-emission circuitry, such as to control light emission by causing selective transmission of current to a light-emitting component. When the data voltage corresponds to a logic high voltage, the latch 218 may improve a quality of its stored data voltage when output from the latch 218.

Keeping the foregoing in mind, when the injected charge 152 is transmitted via the electronic display 12, the RESET_N signal 238, the RD_CLK signal 236, and a data clock (DATA_CLK) signal 248 may temporarily change in value (as represented by the dashed oval corresponding to the injected charge 152). By including the disabling circuitry 210, image data 84 stored in a respective memory cell 214 may be protected against the change in value of the RESET_N signal 238 affecting a value of the stored image data 84.

To elaborate, while the DATA_CLK signal 248 is low or disabled between write operations, the set of registers 222 may not change a state of a signal transmitted to the AND gate 232B. For example, if the last signal to transmit from the registers 222 to the AND gate 232B was a logic high signal, that signal is maintained when the DATA_CLK signal 248 disables. As long as the RESET_N signal 238 is transmitted as a logic high signal, the output from the inverter 240A is a logic low signal and the AND gate 232B does not output a control signal to turn on the switch 228K. Once the RESET_N signal 238 changes to a logic low signal in response to the injected charge 152, the inverter 240A may transmit a logic high signal, which may cause the AND gate 232B to output a logic high signal to the switch 228K. When the switch 228K turns on in response to the logic high signal from the AND gate 232B, the switch 228K provides a connection to the ground 60B system to complete the circuit and enable a data value to be written into the memory cell 214 when the switch 228D is turned on. However, since the injected charge 152 changes the combination of inputs received at the AND gate 232A, the enable signal 230 may not be generated (e.g., may be a logic low signal) and the switch 22D may not be turned on in response to the injected charge 152. By one or more of the switches 228 remaining open (e.g., off) during the electrostatic discharge event, data stored in the memory cell 214 may be protected from corruption due to the voltage changes in supply voltage during the electrostatic discharge. By protecting the memory cell 214 from undesired write or read events, the disabling circuitry may prevent image artifacts from occurring as an effect of the electrostatic discharge.

Referring back to FIG. 12, a third category of image artifacts may correspond to diagram 174, which generally shows zeroed or corrupted data reading or writing from data processing based on one or more corrupted data values. This third category of corruption may result from one or more touch sub-pixels 56 associated with a micro-driver 78 undesirably operating, such as when one or more touch sub-pixels 56 are not responding as expected to the tactile input 58. Two different types of corruption may be associated with diagram 174—pin corruption and supply power corruption.

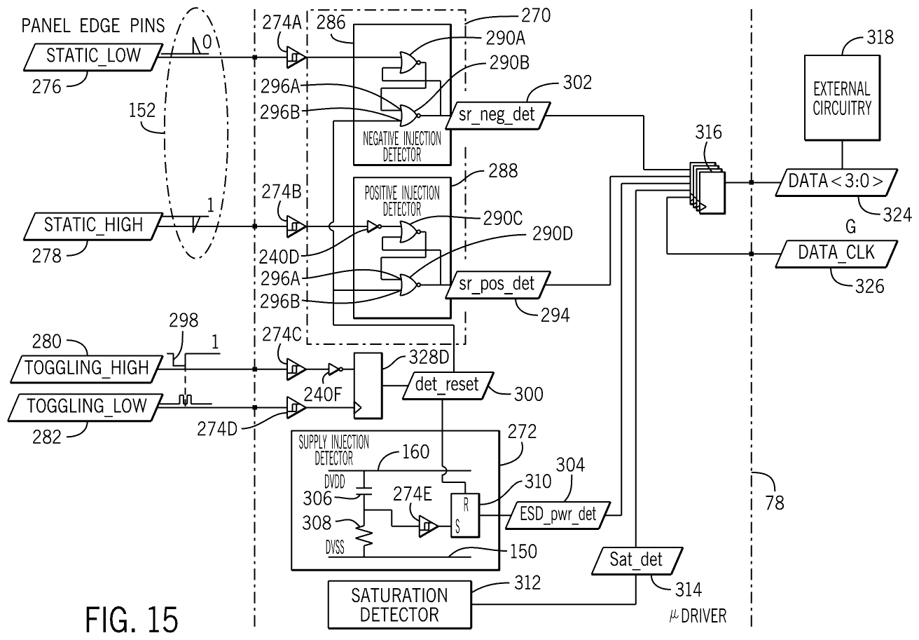

To elaborate on pin corruption, a pin (e.g., input pin, output pin) may be desired to have a constant voltage, either positive or negative. That is, during normal operation, the voltage of the pin may be constant and not move. When voltages of the pins move relative to the local digital supplies of the micro-driver 78, such as in response to electrostatic discharge, data communicated via the pins may be corrupted and incorrect, or at least unreliable. Variable pin voltages may lead to corrupted configuration data, which may affect how the display panel 80 is operated to process tactile inputs 58 or image data 84. One mitigation technique to reduce an impact from pin corruption is to include pin corruption detection circuitry (e.g., pin corruption detector 270 of FIG. 15) that detects pin corruption and generates an indication to instruct the processor that there has been pin corruption. The processor, in response to the indication, may temporarily not listen to (e.g., ignore) data from the micro-driver 78 until the micro-driver 78 is reconfigured or until an injected charge 152 has dissipated. It is noted that other responses or operations may be taken or performed in response to the indication. By using this pin corruption mitigation technique, the processor may not use the corrupted data, thereby avoiding presentation of corresponding image artifacts.

With supply power corruption, similar changes in the supply voltage may occur in response to the electrostatic discharge as with pin corruption—that is, the supply voltage may move in response to the electrostatic discharge when it should otherwise be a constant voltage value, which may lead to corruption of configuration data of the display panel 80. To mitigate supply power corruption, supply bounce detector circuitry (e.g., supply injection detector 272 of FIG. 15) may be included in the micro-driver 78. The supply injection detection circuitry may detect supply power corruption (e.g., by detecting when a supply voltage bounces to another value at least threshold amount of difference from an expected supply value and/or bounces to another value with at least threshold rate of change) and may generate an indication in response to the supply power corruption. The processor core complex 18, in response to the indication, may reset a touch configuration or may temporarily ignore tactile inputs until the injected charge 152 has dissipated. In some systems, the processor core complex 18, in response to the indication, may reset the display panel 80 and/or a portion of the electronic device 10 to reset the supply voltages and reprogram the display panel 80 with uncorrupted configuration data. For example, the processor core complex 18 may, in response to one or more indications, read configuration data stored from a previous configuration operation, write the configuration data to a configuration register 74 of the support circuitry 82, and may reset circuitry of the micro-driver 78, such as the pin corruption detector 270 and/or the supply injection detector 272, to prepare for a future corruption detection operation.

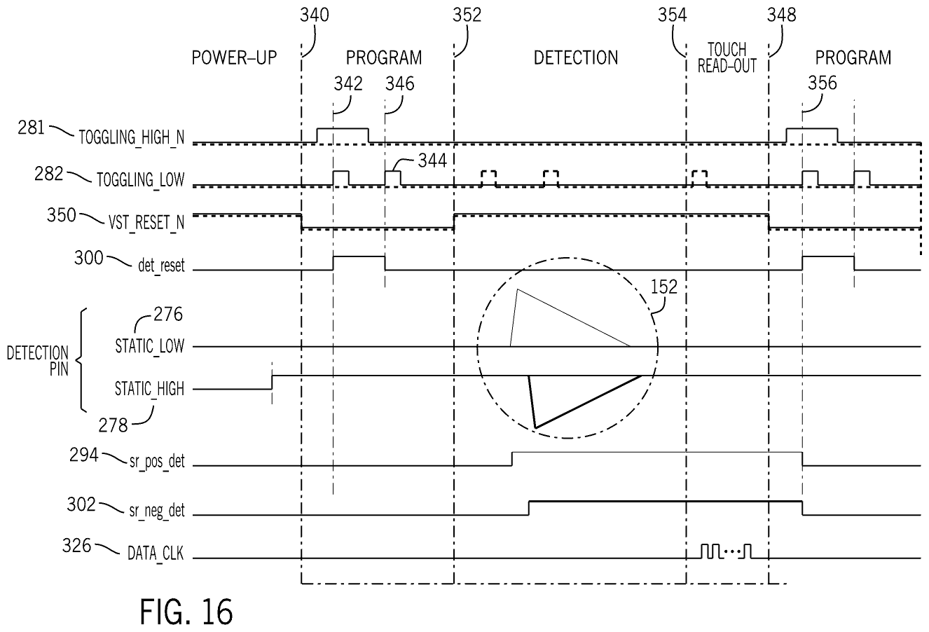

By including pin corruption detection circuitry and supply injection detection circuitry, the electronic device 10 may reduce or eliminate a likelihood of the third category of image artifacts occurring by reloading the configuration data in response to the generated indications. To elaborate, FIG. 15 is a circuit diagram of a pin corruption detector 270 and supply injection detector 272 and FIG. 16 is a timing diagram corresponding to an example operation of the pin corruption detector 270 and the supply injection detector 272 of FIG. 15. For ease of discussion, FIG. 15 and FIG. 16 are referred to together herein. As described above, the pin corruption detector 270 may generate one or more indications to communicate when pin corruption has occurred and the supply injection detector 272 may generate one or more indications to communicate when supply power corruption has occurred. The processor core complex 18 or other processing circuitry may perform a mitigation operation in response to one or more of the indications, such as reloading configuration data stored in association with the display panel 80, to mitigate the third category of image artifact.

The micro-driver 78 may include buffers 274 (buffer 274A, buffer 274B, buffer 274C, buffer 274D, buffer 274E). Some of the buffers 274 (e.g., buffer 274A, buffer 274B, buffer 274C, buffer 274D) may receive control and clocking signals. The buffer 274A may receive a static low (STATIC_LOW) signal 276 and the buffer 274B may receive a static high (STATIC_HIGH) signal 278. The buffer 274C may receive a reset (TOGGLING_HIGH) signal 280 and the output from the inverter 240F may be an inverse TOGGLING_HIGH signal 280 (TOGGLING_HIGH_N 281 in FIG. 16) 280 and the buffer 274D may receive a touch enable (TOGGLING_LOW) signal 282. The TOGGLING_HIGH signal 280 may have a typically a high value that is toggled to trigger flip-flop 328D operations and/or as part of operations of FIG. 16, which the TOGGLING_LOW signal 282 may be typically a low value that is toggled high to trigger flip-flop 328D operations and/or as part of operations of FIG. 16. It is noted that flip-flops, like the flip-flop 328D are edge sensitive as opposed to a latch which may be signal level sensitive. Some of these signals may transmit to the pin corruption detector 270 and/or the supply injection detector 272. The buffer 274E may receive power signals delivered from a high supply voltage 224 (e.g., display supply voltage (DVDD) on path 160) and/or a low voltage supply (e.g., display low reference voltage (DVSS)). Any of the buffers 274 may operate to refine a received signal timing, such as by adjusting a value at input to have a more suitable voltage value for the system and/or may operate to delay the received signal, such as to better align with timing of desired operations and downstream circuitry. In some systems, the buffers 274 may be excluded from the micro-driver 78, such as to reduce power consumed by the electronic device 10 and/or to reduce a total amount of circuitry included in the electronic device 10. In some systems, one or more of the buffers 274 may have a gain greater than or less than 1 and each of the buffers 274 may have a respectively set gain value.

The pin corruption detector 270 may include a negative injection detector 286 and a positive injection detector 288. The negative injection detector 286 and/or the positive injection detector 288 may detect when an otherwise static signal (e.g., a static signal having a constant voltage value) changes state in response to the electrostatic discharge. Although the micro-driver 78 is shown as including each of the negative injection detector 286, the positive injection detector 288, the pin corruption detector 270, and the supply injection detector 272, it should be understood that in some systems only one of these or a subset of these may be used. For example, the electronic device 10 may include the supply injection detector 272 without also including the pin corruption detector 270. As another example, the electronic device 10 may include the pin corruption detector 270 without also including the supply injection detector 272. Furthermore, the pin corruption detector 270 may include the negative injection detector 286, the positive injection detector 288, or both the negative injection detector 286 and the positive injection detector 288. The particular combination of sub-systems to include in one or more micro-drivers 78 may be determined during product testing for a particular type of the electronic device 10, such as based on which type of corruption is more likely to occur with the type of electronic device 10.

With this in mind, the negative injection detector 286 and the positive injection detector 288 may both include two not OR (NOR) gates 290 (NOR gate 290A, NOR gate 290B, NOR gate 290C, NOR gate 290D). The positive injection detector 288 may include an additional inverter 240D.

The positive injection detector 288 may generate a positive pin corruption detection (sr_pos_det) signal 294 (e.g., pin corruption indication) in response to detecting pin corruption and may operate as a set-reset (SR) latch. Pin corruption may result from injected charge 152 and thus the positive injection detector 288 may detect when the STATIC_HIGH signal 278 changes value from the expected logic high level. An output from the NOR gate 290D may be initially a logic low signal and the sr_pos_det signal 294 may change state to a logic high signal when pin corruption is detected. The NOR gate 290D may receive at input 296A a logic low signal and at input 296B a logic high signal (corresponding to TOGGLING_LOW pulse 298 while TOGGLING_HIGH is low (so input of the flip-flop 328D is high) causing generation of det_reset signal 300 as a logic high signal). Normally, the received STATIC_HIGH signal 278 is a logic high input to the buffer 274B. However, when electrostatic discharge affects the electronic device 10, the STATIC_HIGH signal 278 may decrease in value, such as to a logic low value. The NOR gate 290C may then receive a logic high signal from the inverter 240D, which causes the NOR gate 290C to output a logic low signal to the NOR gate 290D. The NOR gate 290D may receive the logic low signal from the NOR gate 290C and a logic low signal as the det_reset signal 300, causing the NOR gate 290D to output a logic high signal as the sr_pos_det signal 294, which indicates that pin corruption has occurred.

Similarly, the negative injection detector 286 may generate a negative pin corruption detection (sr_neg_det) signal 302 (e.g., pin corruption indication) in response to detecting pin corruption and may operate as a set-reset (SR) latch. The negative injection detector 286 may detect when the STATIC_LOW signal 276 changes value from the expected logic low level via the buffer 274A. The output from the NOR gate 290B may be initially a logic low signal (“0”) and the sr_neg_det signal 302 may change state to a logic high signal when pin corruption is detected. The NOR gate 290B may receive, at input 296A, a logic low signal and, at input 296B, a logic high signal (corresponding to a TOGGLING_LOW pulse 298 while TOGGLING_HIGH is low (so input of the flip-flop is high) causing generation of DET_RESET signal 300 as a logic high signal. Normally, the received STATIC_LOW signal 276 is a logic low input to the buffer 274A. However, when electrostatic discharge affects the electronic device 10 (represented via injected charge 152), the STATIC_LOW signal 276 may increase in value, such as to a logic high value. The NOR gate 290A may receive a logic high signal from the buffer 274A, which causes the NOR gate 290A to output a logic low signal to the NOR gate 290B. The NOR gate 290B may receive the logic low signal from the NOR gate 290A and a logic low signal as the det_reset signal 300, causing the NOR gate 290B to output a logic high signal as the sr_neg_det signal 302, which indicates that pin corruption has occurred.

The supply injection detector 272 may generate a supply power corruption detection (ESD_pwr_det) signal 304 in response to detecting supply power corruption. The supply injection detector 272 may include a capacitive component 306 (e.g., a capacitor, a device with capacitive characteristics), a resistive component 308 (e.g., a resistor, a device with resistive characteristics), a buffer 274, and a latch 310 (e.g., a set-reset (SR) latch). The supply injection detector 272 may detect when the display supply voltage (DVDD) on path 160 and/or the display low reference voltage (DVSS) on path 150 changes value from an expected voltage value (e.g., may detect changes due to electrostatic discharge causing the injected charge 152). For example, the capacitive component 306, the resistive component 308, or both may define a difference or rate of change in the value of the display supply voltage (DVDD) on path 160 and/or the display low reference voltage (DVSS) on path 150 that triggers the latch 310 to output the ESD_pwr_det 304 as a logic high signal (e.g., output an indication). Indeed, the supply injection detector 272 may include the resistive component 308 and/or the capacitive component 306 that define a rate of change threshold and amplitude of change threshold that the injected charge 152 is to exceed before the injection indication is generated. When the change in value from the expected voltage value is great enough or fast enough that one or both of the thresholds are crossed, the latch 310 captures the change as a logic high indication as the ESD_pwr_det signal 304. An output of the latch 310 may reset in response to a rising edge of the det_reset signal 300. For example, when the det_reset signal 300 is a logic high signal (“1”), the output from the latch 310 may be a logic low signal (“0”) and the output of the latch 310 may set in response to a rising edge of an output from the buffer 274 combined with the det_reset signal 300 being a logic low signal (“0”).

In some systems, the micro-driver 78 may include a saturation detector circuitry 312. The saturation detector circuitry 312 may sense a current and determine a value of the current (e.g., a current value). The saturation detector circuitry 312 may convert the current value to a voltage value and may determine when the micro-driver 78 experiences touch signal saturation based on the voltage value. When the saturation detector circuitry 312 detects the touch signal saturation, the saturation detector circuitry 312 may generate a saturation detector (sat_det) signal 314, which may be transmitted to one or more flip-flops 316.

The one or more flip-flops 316 may receive one or more of the indications and transmit the indications to circuitry external (e.g., external circuitry 318) to the micro-driver 78, such as the processor core complex 18, for further processing. For example, the one or more flip-flops 316 may receive the sr_neg_det signal 302, the sr_pos_det signal 294, the ESD_pwr_det signal 304, the sat_det signal 314, or any combination thereof. The one or more flip-flops 316 may output the indications as a collection of parallel data (e.g., data<3:0>324) to external circuitry 318. A number of flip-flops 316 may equal a number of the corruption detection indications generated by the various sub-systems of the micro-driver 78 (e.g., the sr_neg_det signal 302, the sr_pos_det signal 294, the ESD_pwr_det signal 304, the sat_det signal 314). The data<3:0>324 may output from the flip-flops 316 in response to a clocking transition of a data clock (DATA_CLK) signal 326. The external circuitry 318 may include processing circuitry, such as the support circuitry 82, the processor core complex 18, or the like. The external circuitry 318 may determine to refresh the display panel 60 in response to the data<3:0>324 indicating that at least one of the sr_neg_det signal 302, the sr_pos_det signal 294, the ESD_pwr_det signal 304, and the sat_det signal 314. The display panel 60 refresh may reload configuration data and may mitigate detected corruption.

As noted above, there are cases, where the external circuitry 318 (e.g., the processor core complex 18) may perform different mitigation operations in response to the different corruption detection indications. For example, the data<3:0>324 indicating the sr_neg_det signal 302 may trigger a first type of mitigation operation while the data<3:0>324 indicating the sr_pos_det signal 294 may trigger a second type of mitigation operation. One type of mitigation operation may include reloading configuration data stored in the configuration register 74. Another type of mitigation operation may include ignoring data received via a first input while the sr_pos_det signal 294 is a logic high signal. Another type of mitigation operation may include ignoring data received via a second input while the sr_neg_det signal 302 is a logic high signal. Another type of mitigation operation may include refreshing a touch configuration and/or include ignoring a touch operation result while the ESD_pwr_det signal 304 is a logic high signal.

Referring now to FIG. 16, various signals described above are shown in the timing diagram of FIG. 16. Here, at power up, the TOGGLING_LOW signal 282, the TOGGLING_HIGH_N signal 281, the STATIC_LOW signal 276, the STATIC_HIGH signal 278, and the DATA_CLK signal 326 may have a logic low value. At time 340, the TOGGLING_LOW signal 282 and TOGGLING_HIGH_N signal 281 may be toggled when programming a display configuration of the display panel 80, which may cause the det_reset signal 300 to change state to a logic high value at time 342. A second pulse 344 of the TOGGLING_LOW signal 282 may be used to lower the det_reset signal 300 at time 346, where the det_reset signal 300 may correspond to a flag that is selectively toggled. The display configuration programming may occur at a 60 Hz or at any suitable interval. That is, a frequency of occurrence between the time 340 and a time 348 corresponding to a start of a subsequent configuration programming operation may correspond to 60 Hz. A touch detection operation may begin in response to a rising edge of the VST_RESET_N signal 350 at time 352, which is lowered during the programming operation between time 340 and time 352. However, during the touch detection operation, the injected charge 152 may be received due to electrostatic discharge. The positive injection detector 288 may detect the injected charge 152 via the STATIC_LOW signal 276 (e.g., a positive injected voltage affecting the STATIC_LOW signal 276) and may generate a logic high signal as the sr_pos_det signal 294. Similarly, the negative injection detector 286 may detect the injected charge 152 via the STATIC_HIGH signal 278 (e.g., a negative injected voltage affecting the STATIC_HIGH signal 278) and may generate a logic high signal as the sr_neg_det signal 302. Furthermore, after time 354, the DATA_CLK signal 326 may transmit to assist external circuitry in reading the touch read-out signals. Since the touch detection was corrupted from electrostatic discharge, the touch read-out signals may be ignored from the micro-driver 78 and instead the DATA_CLK signal 326 may be used when reading out the flip-flops 316. Other touch read-out signals may still be read out from other micro-drivers 78 not experiencing corruption from the electrostatic discharge. At time 356, the logic high states of the corruption indications (e.g., sr_neg_det signal 302, sr_pos_det signal 294) may cause processing circuitry to reset the display panel 80 via TOGGLING_LOW signal 282, among other signals, which are used to reset configurations and pin and supply corruption detection circuitry to prepare for a future touch operation. Once, the pin detection circuitry is reset, the corruption indications (e.g., sr_neg_det signal 302, sr_pos_det signal 294) may also be reset to low logic values (e.g., “0”) after time 356.

Technical effects of systems and methods described herein may include mitigation of effects of electrostatic discharge on operations of one or more micro-drivers and/or of a display panel. By doing so, the frequency of occurrence and duration of image artifacts may reduce, thereby improving user experience and presented image quality. Furthermore, when presented image quality improves, so too may consumption of resources by the electronic device. For example, when image quality is low or poor, incorrect or undesired applications may be executed, which may consume additional processing resources and increase wear on components of the electronic device. However, when the present image quality improves and fewer image artifacts are presented, correct or desired application may be more likely to be selected and thus low processing resources may be consumed and targeted to operation of desired applications. Systems described include mitigation systems and methods implemented at the micro-driver-level to detect when corruption has occurred of data pins or supply voltages and/or to protect one or more memory cells of the micro-driver from being written to in response to an injected charge. Based on the detection of the corruption, processing circuitry, such as the processing core complex of the electronic device, may reload or generate a new configuration to be written to a configuration register associated with support circuitry of the display panel (e.g., display panel driver, display panel control circuitry). In some cases, the configuration may be generated new or modified to cause the display panel to be refreshed at 60 Hz or some other suitable frequency to mitigate some corruption that occurs in response to electrostatic discharge. Sometimes the support circuitry may detect electrostatic discharge and reload a configuration into the configuration register in response to the electrostatic discharge. By writing a new configuration to the display panel, supply voltages and pin reading operations used by the support circuitry may be reset, and thus mitigated, in view of the previous electrostatic discharge. Furthermore, some signal states may be used to increase a resistance to electrostatic discharges. Indeed, a TOGGLING_HIGH signal that is by default logic high state (e.g., having a normally logic high state, being a signal known as a static logic high signal) and that a TOGGLING_LOW signal that is sensitive to rising edges only may help increase a resistance of an electronic device to electrostatic discharges.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device, comprising:
an electronic display comprising a plurality of display pixels configured to emit light to present an image frame in response to control signals from a micro-driver associated with a subset of the plurality of display pixels; and
processing circuitry configured to:
detect a corruption from electrostatic discharge received via the micro-driver following a tactile input to the electronic display; and
perform a mitigation operation in response to the corruption.

2. The electronic device of claim 1, wherein the micro-driver comprises a pin corruption detector configured to generate a pin corruption indication in response to the electrostatic discharge, wherein the processing circuitry is configured to detect the corruption in response to receiving the pin corruption indication from the pin corruption detector and perform the mitigation operation based on the corruption.

3. The electronic device of claim 1, wherein the micro-driver comprises a supply injection detector configured to generate an injection indication in response to the electrostatic discharge generating an injected charge on a supply voltage, and wherein the processing circuitry is configured to detect the corruption in response to receiving injection indication from the supply injection detector.

4. The electronic device of claim 3, wherein the supply injection detector comprises a resistive component and a capacitive component that define a rate of change threshold and amplitude of change threshold that the injected charge is to exceed before the injection indication is generated.

5. The electronic device of claim 1, wherein the processing circuitry is configured to receive an indication from the micro-driver and detect the electrostatic discharge based on the reception of the indication.

6. The electronic device of claim 5, wherein the processing circuitry is configured to determine the mitigation operation based on a type of the indication.

7. The electronic device of claim 1, comprising disabling circuitry configured to selectively disable a write path of a memory of the micro-driver when a read clock is transmitted.

8. The electronic device of claim 1, wherein the electronic display comprises a light-emitting diode (LED) display, a micro light-emitting diode (micro-LED), an organic light-emitting diode (OLED) display, a liquid crystal display (LCD), or a digital micromirror device (DMD) display.

9. A method, comprising:
writing configuration data to a configuration register;
receiving a tactile input to an electronic display panel;
receiving an indication that electrostatic discharge occurred in response to the tactile input;
modifying the configuration data in response to the indication; and
writing the modified configuration data to the configuration register.

10. The method of claim 9, comprising:
determining that the configuration data stored in the configuration register was corrupted from the electrostatic discharge based on the indication; and
reading the configuration data from a memory external to the configuration register in response to determining that the configuration data stored in the configuration register was corrupted.

11. The method of claim 10, wherein the configuration data is configured to program a first refresh rate, and wherein the modified configuration data is configured to program a second refresh rate.

12. The method of claim 11, wherein the second refresh rate comprises 60 Hertz (Hz).

13. A system comprising:
electrostatic discharge detection circuitry;
a configuration register configured to program a display panel based on configuration data stored in the configuration register; and
processing circuitry communicatively coupled to the electrostatic discharge detection circuitry and to the configuration register, wherein the processing circuitry is configured to:
write the configuration data to the configuration register;
receive an indication that electrostatic discharge occurred; and
write the configuration data to the configuration register in response to the indication.

14. The system of claim 13, wherein the electrostatic discharge detection circuitry comprises:
a pin corruption detector configured to generate the indication in response to the electrostatic discharge causing a static signal to change state; and
a supply injection detector configured to generate the indication in response to the electrostatic discharge generating an injected charge on a supply voltage that corresponds to a rate of change, an amplitude, or both that respectively cross a rate of change threshold, an amplitude of change threshold, or both associated with the supply injection detector.

15. The system of claim 14, wherein the pin corruption detector comprises a negative injection detector configured to detect when a static signal changes state in response to the electrostatic discharge.

16. The system of claim 15, wherein the negative injection detector comprises a first not-OR gate coupled to a second not-OR gate, and wherein an output from the second not-OR gate is configured to couple to an input of the first not-OR gate and an input to a flip-flop external to the negative injection detector.

17. The system of claim 14, wherein the pin corruption detector comprises a positive injection detector configured to detect when a static high signal changes state in response to the electrostatic discharge.

18. The system of claim 17, wherein the positive injection detector comprises a first not-OR gate coupled to a second not-OR gate, and wherein an output from the second not-OR gate is configured to couple to an input of the first not-OR gate and an input to a flip-flop external to the positive injection detector.

19. The system of claim 13, wherein the configuration data is configured to program a refresh rate.

20. The system of claim 19, wherein the refresh rate comprises 60 Hertz (Hz).

21. The system of claim 13, wherein the processing circuitry is disposed within an electronic display.

22. The system of claim 13, wherein the electrostatic discharge detection circuitry comprises saturation detector circuitry configured to sense a current value and, based on the current value, generate the indication that the electrostatic discharge occurred.
